(19) United States
(12) Patent Application Publication
(10) Pub. No.: US 2013/0241477 A1
(43) Pub. Date: Sep. 19, 2013

(54) Wireless Charging System and Method for Controlling the Same

(71) Applicant: WISTRON CORPORATION, New Taipei City (TW)

(72) Inventor: Yi-Sheng KAO, New Taipei City (TW)

(73) Assignee: WISTRON CORPORATION, New Taipei City (TW)

(21) Appl. No.: 13/828,317

(22) Filed: Mar. 14, 2013

(30) Foreign Application Priority Data
Mar. 15, 2012 (TW) 101108918

(51) Int. Cl. H02J 7/02

(52) U.S. Cl. CPC H02J 7/025
USPC 320/108; 320/162

(57) ABSTRACT

A wireless charging system and a method for controlling the wireless charging system are disclosed. The wireless charging system is used for charging a rechargeable device. The wireless charging system includes a charging circuit, a power supply module, a power switching module, a power sensing terminal, and a comparison module. The power supply module is used for providing a DC power signal. The power switching module converts the DC power signal to an AC power signal based on a switching frequency. The power sensing terminal is used for sensing a coupling voltage according to the AC power signal to charge the rechargeable device. The comparison module compares the coupling voltage with a default value, wherein the default value is set according to the switching frequency. When the coupling voltage is less than the default value, the comparison module controls the power switching module to increase the switching frequency.

### BACKGROUND OF THE INVENTION

1. Field of the Invention

The present invention relates to a wireless charging system and a method for controlling the wireless charging system, and more particularly, to a wireless charging system which can dynamically adjust a coupling voltage and a method fir controlling the wireless charging system.

2. Description of the Related Art

Various kinds of electronic devices have emerged with the advancement of technology; in the meantime, these electronic devices have created more demands for electricity. Due to different charging interfaces of electronic devices, it is troublesome for a user to charge his/her devices when there's no available adapter. Therefore, a prior art technique is proposed to implement a wireless charging method through magnetic induction.

However, in the prior art wireless charging technique, the charging terminal would keep transmitting a coupling voltage to a rechargeable device without knowing the load and the required voltage value of the rechargeable device and could waste a considerable amount of power. On the other hand, if it is necessary to increase the transmitting power, the coupling circuit and the power characteristics of the rechargeable device must be also taken into consideration in addition to increasing the voltage or current. Therefore, in prior art techniques, the voltage level of the coupling voltage is limited for lower manufacturing cost since building a circuit which can sustain high voltage is not cost effective.

Therefore, it is necessary to propose a new wireless charging system and a method for controlling the new wireless charging system to overcome the deficiencies of prior art techniques.

### SUMMARY OF THE INVENTION

It is an object of the present invention to provide a wireless charging system which can dynamically adjust a coupling voltage.

It is another object of the present invention to provide a method for controlling the wireless charging system.

In order to achieve the above object, the present invention discloses a wireless charging system for charging a rechargeable device. The wireless charging system comprises a charging circuit, a power supply module, a power switching module, a power sensing terminal, and a comparison module. The power supply module is used for providing a DC power signal on the charging circuit. The power switching module is electrically connected to the power supply module and converts the DC power signal to an AC power signal based on a switching frequency. The power sensing terminal is disposed on the charging circuit and used for sensing a coupling voltage according to the AC power signal to charge the rechargeable device. The comparison module is electrically connected with the power sensing terminal for comparing the coupling voltage with a default value, wherein the default value is set by the power switching module according to the switching frequency; when the coupling voltage is less than the default value, the comparison module controls the power switching module to increase the switching frequency.

The present invention also provides a method for controlling a wireless charging system to charge a rechargeable device. The method comprises the following steps: providing a dc power signal; converting the dc power signal into an AC power signal based on a switching frequency; sensing a coupling voltage according to the AC power signal to charge the rechargeable device; comparing the coupling voltage with a default value, wherein the default value is set according to the switching frequency; and when the coupling voltage is less than the default value, increasing the switching frequency to increase the AC power signal.

### BRIEF DESCRIPTION OF THE DRAWINGS

FIG. 1 illustrates a structural view of a wireless charging system of the present invention;

FIG. 2 illustrates a circuit diagram of an embodiment of the present invention;

FIG. 3 illustrates a flow chart of a method controlled by the wireless charging system of the present invention; and

FIG. 4 illustrates a flow chart of an embodiment of the wireless charging system of the present invention.

### DETAILED DESCRIPTION OF THE PREFERRED EMBODIMENT

The advantages and innovative features of the invention will become more apparent from the following detailed description when taken in conjunction with the accompanying drawings.

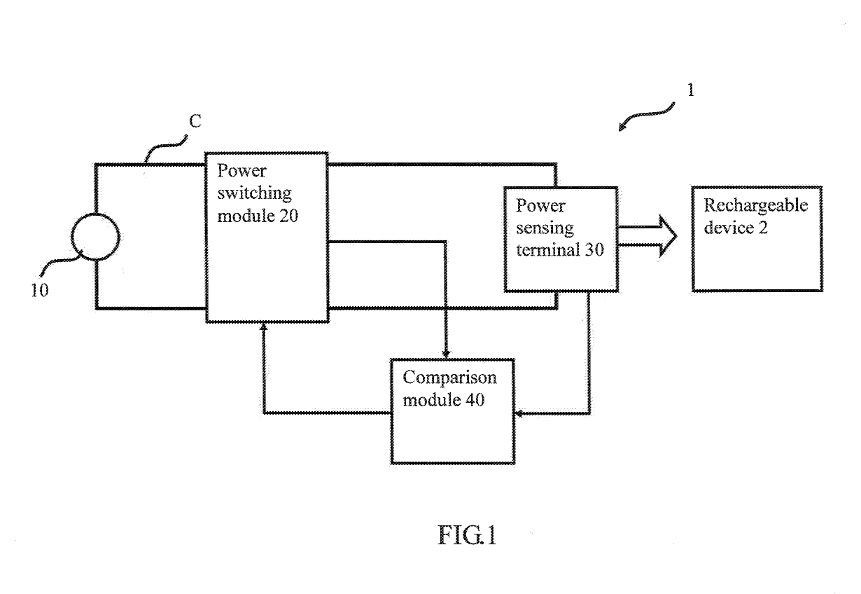

Please refer to FIG. 1 for a structural view of a wireless charging system of the present invention.

The present invention provides a wireless charging system 1 for charging a rechargeable device 2 through wireless charging. The wireless charging system 1 comprises a charging circuit C, a power supply module 10, a power switching module 20, a power sensing terminal 30, and a comparison module 40. The above modules can be implemented by hardware structures; however, they can be implemented by firmware or software structures as well. The power supply module 10 can be a battery module disposed on the charging circuit C for providing a dc power signal. The power switching module 20 is electrically connected with the power supply module 10 for converting the dc power signal into an AC power signal. The power sensing terminal 30 is disposed on the charging circuit C for sensing a coupling voltage according to the AC power signal and for charging the rechargeable device 2 through magnetic induction. The power switching module 20 determines the current and the voltage value of the AC power signal according to the switching frequency; therefore, when the switching frequency of the power switching module 20 increases, the coupling voltage of the power sensing terminal 30 increases, which can be used to charge the rechargeable device 2 having a heavy load/power demand. On the other hand, when the rechargeable device 2 does not have a large power demand, the switching frequency of the power switching module 20 is also low.

The comparison module 40 is electrically connected with the power sensing terminal 30 and the power switching module 20 for comparing the coupling voltage with the default value, wherein the default value is set by the power switching module 20 according to its switching frequency. Since the coupling voltage of the power sensing terminal 30 corresponds to the switching frequency set by the power switching module 20, the power switching module 20 can obtain the coupling voltage based on the switching frequency. Consequently, the power switching module 20 dynamically sets the default value based on the current switching frequency; when the switching frequency changes, the power switching module 20 changes the default value. When the rechargeable device 2 is having a heavy load, which means the rechargeable device 2 requires a larger current, thereby causing the coupling voltage to drop. When the coupling voltage is less than the default value, the comparison module 40 controls the power switching module 20 to increase the switching frequency and to increase the coupling voltage to meet the power demand of the rechargeable device 2.

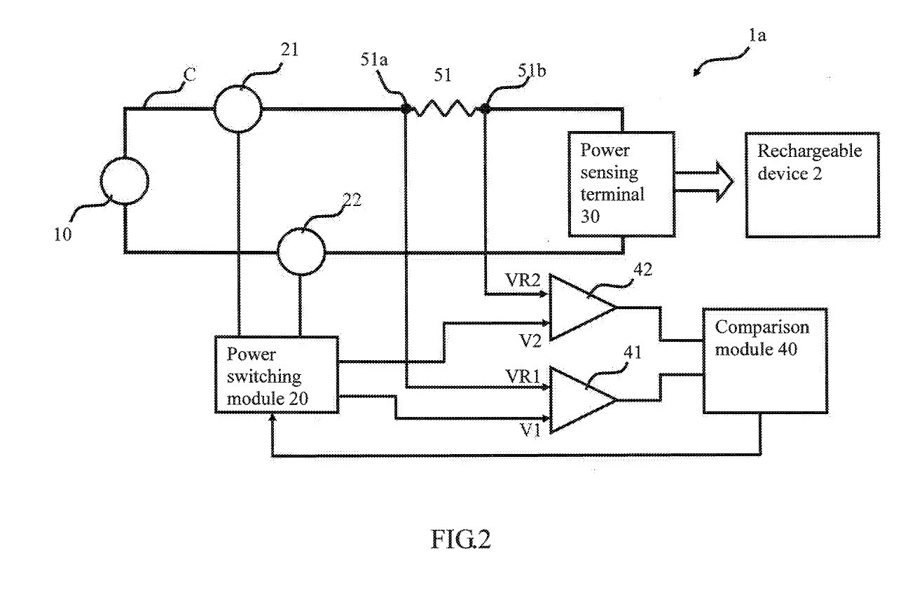

Please refer to FIG. 2 for a circuit diagram of an embodiment of the present invention.

FIG. 2 illustrates a preferred embodiment of the present invention; however, the wireless charging system 1a can be implemented by other circuit structures. In this embodiment, the charging circuit C of the wireless charging system 1a also comprises a first switch module 21, a second switch module 22, and a resistor 51. The power switching module 20 is electrically connected with the first switch module 1 and the second switch module 22. The first switch module 21 and the second switch module 22 can be formed by Metal-Oxide-Semiconductor Field-Effect Transistors (MOSFETs) or any other suitable transistors. The first switch module 21 and the second switch module 22 are both disposed on the charging circuit C; the power switching module 20 controls the ON/OFF of the first switch module 21 and the second switch module 22 according to the switching frequency to convert the dc power signal into the AC power signal. It is noted that the mechanism of converting the dc power signal into the AC power signal is well known in art, it will not be further described. In addition, the present invention can use other circuit implementations other than that shown in FIG. 2 to convert the dc power signal.

The resistor 51 is disposed on the charging circuit C. The resistor 51 comprises a first end 51a and a second end 51b, wherein the second end 51b is cascaded with the power sensing terminal 30. The first end 51a and the second end 51b of the resistor 51 comprises a first voltage value VR1 and a second voltage value VR2 respectively. In this embodiment, the comparison module 40 is further electrically connected with the first comparator 41 and the second comparator 42. The first comparator 41 compares the first voltage value VR1 with a first reference value V1; the second comparator 42 compares the second voltage value VR2 with a second reference value V2. Similar to the default value, the first reference value V1 and the second reference value V2 are set by the power switching module 20 according to the switching frequency and are not fixed values. Since the resistor 51 is cascaded with the power sensing terminal 30, the same current flow through the resistor 51 and the power sensing terminal 30. Consequently, the present invention can project the relationship between the coupling voltage and the default value by comparing the first voltage value VR1 and the second voltage value VR2 with the first reference value V1 and the second reference value V2 respectively.

For example, when the wireless charging system 1a is charging the rechargeable device 2 having a heavy load, the increased current causes the coupling voltage to drop; therefore, the voltage difference between the first voltage value VR1 and the second voltage value VR2 becomes larger. At this moment the second voltage value VR2 will drop below the second reference value V2. So when the second comparator 42 compares that the second voltage value VR2 is less than the second reference value V2, and the first comparator 41 finds out that the first voltage value VR1 is still larger than the first reference value V1, the comparison module 40 determines that the wireless charging system 1a needs to increase the coupling voltage. Thereafter, the comparison module 40 controls the power switching module 20 to increase the switching frequency.

On the other hand, when the rechargeable device 2 is removed or out of order, a considerable amount of power could accumulate at the power sensing terminal 30 to cause the first voltage value VR1 to rise above the first reference value V1. Therefore, when the first voltage value VR1 increases from less than the first reference value V1 to larger than the first reference value V1, the comparison module 40 controls the power switching module 20 to decrease the switching frequency to stop transmitting the coupling voltage. Later, when the second comparator 42 finds out that the second voltage value VR2 is less than the second reference value V2, the comparison module 40 can controls the power switching module 20 to increase the switching frequency again.

Consequently, through continuous comparing process, the wireless charging system 1a can dynamically adjust the outputted coupling voltage. The power sensing terminal 30 can adjust the coupling voltage according to the load of the rechargeable device 2 and does not need to output a fixed coupling voltage, thereby preventing unnecessary power consumption. On the other hand, the wireless charging system 1a can adjust the coupling voltage in a stepwise manner by comparing the first voltage value VR1 and second voltage value VR2 to avoid changing the coupling voltage frequently. It is noted that the above process is only for illustration, there can be other method or process to control the power switching module 20 to achieve the same object.

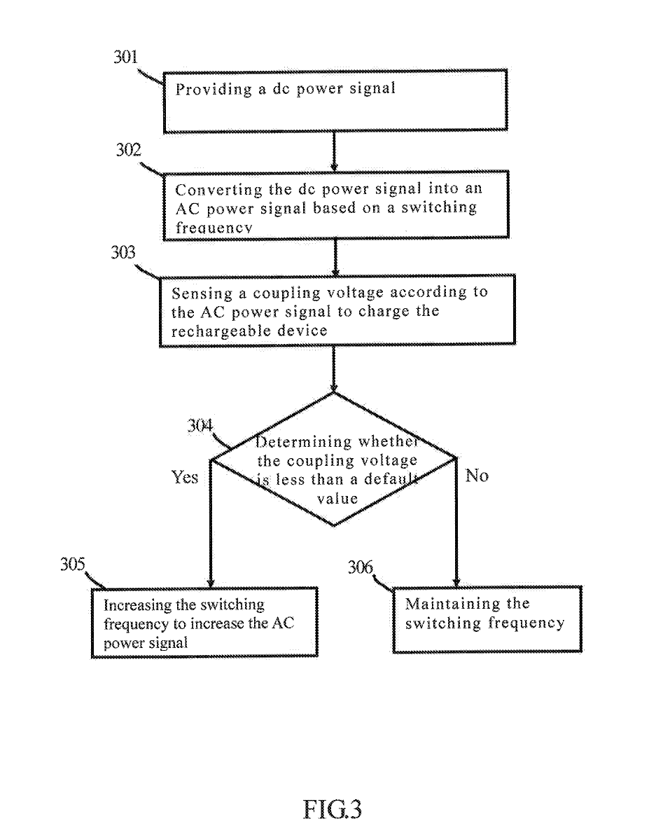

Please refer to FIG. 3 for a flow chart of a method controlled by the wireless charging system of the present invention. It is noted that the although the method is controlled by the wireless charging system 1a to achieve the object of the present invention, the method can be applied in other circuit to serve its purpose.

First the method goes to step 301: providing a dc power signal.

When the wireless charging system 1a is going to charge the rechargeable device 2, at first the power supply module 10 of the wireless charging system 1a provides the dc power signal.

Then the method goes to step 302: converting the dc power signal into an AC power signal based on a switching frequency.

In an embodiment of the present invention, the power switching module 20 turns on the first switch module 21 and the second switch module 22 on the charging circuit C respectively based on the switching frequency to convert the dc power signal into the AC power signal. In the step 302, the power switching module 20 can convert the dc power signal based on a low switching frequency.

Then the method goes to step 303: sensing a coupling voltage according to the AC power signal to charge the rechargeable device.

Then the power sensing terminal 30 senses the coupling voltage according to the received AC power signal to charge the rechargeable device 2 though wireless charging.

Then the method goes to step 304: determining whether the coupling voltage is less than a default value.

Then the comparison module 40 compares the coupling voltage with the default value to determine whether the coupling voltage is less than the default value.

If the coupling voltage is less than the default value, then the method goes to step 305: increasing the switching frequency to increase the AC power signal.

If so, then it is determined that the rechargeable device 2 requires a higher current, so the comparison module 40 controls the power switching module 20 to increase the switching frequency to boost the coupling voltage, thereby providing enough power to the rechargeable device 2.

If the coupling voltage is not less than the default value, then the step goes to step 306: maintaining the switching frequency.

If the coupling voltage is not less than the default value, it is determined that the coupling voltage can meet the power requirement of the rechargeable device 2; therefore, the comparison module 40 controls the power switching module 20 to maintain the same switching frequency.

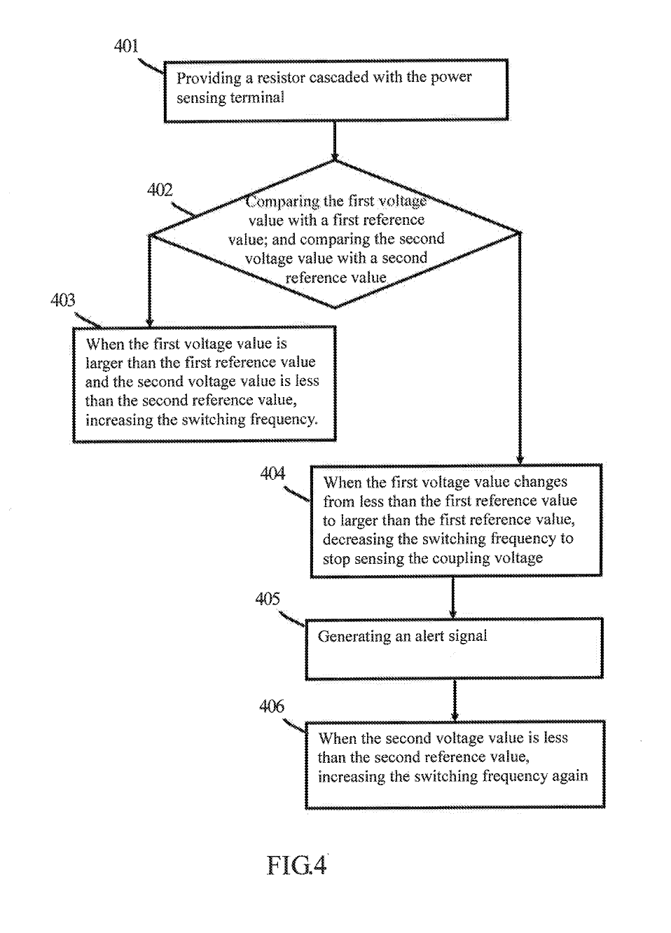

The step 304 of determining whether the coupling voltage is less than a default value is further explained in FIG. 4, which illustrates a flow chart of an embodiment of the wireless charging system of the present invention. It is noted that other method or steps can be used for determining whether the coupling voltage is less than a default value.

First the method goes to step 401: providing a resistor cascaded with the power sensing terminal.

The resistor 51 is disposed on the charging circuit C and cascaded with the power sensing terminal 30. The resistor 51 comprises a first end 51a and a second end 51b; the first end 51a and the second end 51b of the resistor 51 comprises a first voltage value VR1 and a second voltage value VR2 respectively.

Then the method goes to step 402: comparing the first voltage value with a first reference value; and comparing the second voltage value with a second reference value.

The first comparator 41 compares the first voltage value VR1 with the first reference value V1, the second comparator 42 compares the second voltage value VR2 with the second reference value V2 to obtain a change of the coupling voltage. The first reference value V1 and the second reference value V2 are set by the power switching module 20 according to the switching frequency. Since the first reference value V1 and the second reference value V2 are set by the power switching module 20 according to the switching frequency, they are not fixed values.

Based on the results of comparing the first voltage value VR1 with the first reference value V1 and comparing the second voltage value VR2 with the second reference value V2, different embodiments can be implemented. For example, in step 403: when the first voltage value is larger than the first reference value and the second voltage value is less than the second reference value, increasing the switching frequency.

When the second comparator 42 learns that the second voltage value VR2 is less than the second reference value V2, and the first comparator 41 finds out that the first voltage value VR1 is still larger than the first reference value V1, the comparison module 40 determines that the comparison module 40 determines that the wireless charging system 1a needs to increase the coupling voltage. Thereafter, the comparison module 40 controls the power switching module 20 to increase the switching frequency.

Or the method goes to step 404: when the first voltage value changes from less than the first reference value to larger than the first reference value, decreasing the switching frequency to stop sensing the coupling voltage.

When the first voltage value VR1 changes from less than the first reference value V1 to larger than the first reference value V1, it is possible for the power sensing terminal 30 to experience a high voltage level of coupling voltage due to short circuit; therefore, the comparison module 40 controls the power switching module 20 to decrease the switching frequency to stop transmitting the coupling voltage.

Then the method goes to step 405: generating an alert signal.

At this time the wireless charging system 1a can use a light emitting module (not shown in figure) to generate the alert signal to inform the user any abnormal conditions.

Finally the method goes to step 406: when the second voltage value is less than the second reference value, increasing the switching frequency again.

When the second comparator 42 learns that the second voltage value VR2 drops below the second reference value V2 again, the comparison module 40 controls the power switching module 20 to increase the switching frequency again.

It is noted that the method is not limited to the order of the steps disclosed herein, and the method can have another order of steps as long as the object of the present invention is fulfilled.

Therefore, the wireless charging system 1a of the present invention can dynamically adjust the coupling voltage according to the condition of the rechargeable device 2, and can also adjust the coupling voltage in a stepwise manner by comparing the voltage values at both ends of the resistor to avoid changing the voltage frequently.

It is noted that the above-mentioned embodiments are only for illustration, it is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A wireless charging system for charging a rechargeable device, the wireless charging system comprising:
a charging circuit;
a power supply module for providing a dc power signal on the charging circuit;
a power switching module electrically connected with the power supply module for converting the dc power signal into an AC power signal based on a switching frequency;
a power sensing terminal on the charging circuit for sensing a coupling voltage according to the AC power signal to charge the rechargeable device; and
a comparison module electrically connected with the power sensing terminal for comparing the coupling voltage with a default value, wherein the default value is set by the power switching module according to the switching frequency; when the coupling voltage is less than the default value, the comparison module controls the power switching module to increase the switching frequency.

2. The wireless charging system as claimed in claim 1, wherein the power switching module is electrically connected with a first switch module and a second switch module, the first switch module and the second switch module are disposed on the charging circuit; the power switching module controls the first switch module and the second switch module to generate the AC power signal.

3. The wireless charging system as claimed in claim 1, wherein the wireless charging system further comprises a resistor disposed on the charging circuit, the resistor comprises a first end and a second end cascaded to the power sensing terminal, wherein the first end of the resistor comprises a first voltage value, and the second end comprises a second voltage value.

4. The wireless charging system as claimed in claim 3, wherein the comparison module is electrically connected with a first comparator and a second comparator;
the first comparator compares a first voltage value of the resistor with a first reference value; and
the second comparator compares a second voltage value of the resistor with a second reference value.

5. The wireless charging system as claimed in claim 4, wherein the power switching module changes the first reference value and the second reference value according to the switching frequency.

6. The wireless charging system as claimed in claim 5, wherein when the first voltage value changes from less than the first reference value to larger than the first reference value, the comparison module controls the power switching module to decrease the switching frequency to stop sensing the coupling voltage.

7. The wireless charging system as claimed in claim 6, wherein when the second voltage value is less than the second reference value, the comparison module controls the power switching module again to increase the switching frequency.

8. The wireless charging system as claimed in claim 5, wherein when the first voltage value is larger than the first reference value and the second voltage value is less than the second reference value, the comparison module controls the power switching module to increase the switching frequency.

9. A method for controlling a wireless charging system to charge a rechargeable device, the method comprising the following steps:
providing a dc power signal;
converting the dc power signal into an AC power signal based on a switching frequency;
sensing a coupling voltage according to the AC power signal to charge the rechargeable device;
comparing the coupling voltage with a default value, wherein the default value is set according to the switching frequency; and
when the coupling voltage is less than the default value, increasing the switching frequency to increase the AC power signal.

10. The method for controlling the wireless charging system as claimed in claim 9, wherein the method further comprises the following steps:
providing a resistor cascaded with the power sensing terminal, the resistor comprising a first end and a second end, wherein the first end of the resistor comprises a first voltage value, and the second end comprises a second voltage value;
comparing the first voltage value with a first reference value; and
comparing the second voltage value with a second reference value.

11. The method for controlling the wireless charging system as claimed in claim 10, wherein the method further comprises the following step:
changing the first reference value and the second reference value according to the switching frequency.

12. The method for controlling the wireless charging system as claimed in claim 11, wherein the method further comprises the following step:
when the first voltage value is larger than the first reference value and the second voltage value is less than the second reference value, increasing the switching frequency.

13. The method for controlling the wireless charging system as claimed in claim 11, wherein the method further comprises the following steps:
when the first voltage value changes from less than the first reference value to larger than the first reference value, decreasing the switching frequency to stop sensing the coupling voltage; and
generating an alert signal.

14. The method for controlling the wireless charging system as claimed in claim 13, wherein the method further comprises the following step:
when the second voltage value is less than the second reference value, increasing the switching frequency again.
